(19) United States
(12) Patent Application Publication
(10) Pub. No.: US 2008/0052326 A1
(43) Pub. Date: Feb. 28, 2008

(54) Signature Based Client Automatic Data Backup System

(75) Inventors: Stephen A. Evanchik, Malden, MA (US); Louis M. Weitzman, Brookline, MA (US)

Correspondence Address: INTERNATIONAL BUSINESS MACHINES CORPORATION, IPLAW DEPARTMENT, 2455 SOUTH ROAD - MS P386, POUGHKEEPSIE, NY, 12601, US

(73) Assignee: INTERNATIONAL BUSINESS MACHINES CORPORATION, Armonk, NY (US)

(21) Appl. No.: 11/466,138

(22) Filed: Aug. 22, 2006

(51) Int. Cl. G06F 17/30

(52) U.S. Cl. 707/204

(57) ABSTRACT

A client computer identifies data files to be backed up according to corresponding backup signatures in a backup signature list. The client computer sends a backup copy of each of the identified data files to backup server(s) according to a predetermined plan. The backup copies are preferably associated with the client computer at the backup server.

### BACKGROUND OF THE INVENTION

The present invention relates to automatically saving data files in a computer system and more particularly to saving backup data files of a plurality of client systems in a network of attached client systems.

Current backup systems typically require user involvement in order to identify the assets to be backed up, to be excluded from backup, to be scheduled for backup, and to be managed for version resolution and integrity. These tasks require the user to be very knowledgeable about how applications produce and store data. A user that is not an expert risks backing up too little of their critical assets or too many irrelevant assets for example.

US Patent Application Publication No. 2004/0003272A1 “Distributed autonomic backup” of Bantz et al. filed Jun. 28, 2002 and incorporated herein by reference provides a reliable and secure method of automatically backing up a client's data on a personal computer by using excess storage capacity on a set of one or more predetermined computers, without the need for dedicated servers, server disks, removable storage media, or intervention by a user to assist with the storage devices. The methods permit a user, be it an individual or a large company, to inexpensively and securely back up information without the need to acquire additional expensive hardware.

U.S. Pat. No. 6,728,711 “Automatic backup/recovery process” of Richard filed May 2, 2001 and incorporated herein by reference discloses a backup procedure which performs a systematic analysis of the different elements of the configuration, for the purpose of transforming them into a corresponding set of backup objects. Backup objects include files, directories, volume names or labels, security attributes (Access Control Lists in Windows NT), as well as OS-specific markers which are dependent on a specific file, such as, for instance an entry in the FAT for MS-DOS. Each backup object is systematically analyzed and sent to a remote server with its identification, attributes, signature and content. The backup process takes advantage of the HyperText Transfer Protocol (HTTP) and each backup object is encapsulated within a HTTP or HTTPS POST or PUT request which is transmitted to a remote server. The backup procedure is associated with a process for automatically creating a bootable CDROM having a bootable partition comprising a set of files systems driver for controlling different file system types, such as NTFS, FAT, FAT32, i-NODE, but also CDFS, and an executable file for carrying out the automatic re-establishment of the backup objects corresponding to a user's configuration.

What is needed is an automatic method of identifying assets and scheduling them to be backed up.

### SUMMARY OF THE INVENTION

The present invention uses a unique data profiling technique to identify a set of data files, called assets, to be used in an automated process with little or no user involvement. In one example, this technique can be used to identify the assets relevant in a data backup process. Using a profile of the application and the assets that application creates, the user does not have to specify what specific asset needs to be backed up. Rather, the user is required to specify that some, all or none of an application's assets must be backed up. The system takes care of finding assets and scheduling them to be backed up. This process to can be extended to identify assets to be indexed for desktop searching.

The Present invention is based on a standard client/server backup system with the client system augmented to include a set of services to automate the backup process. The client system has a backup service that searches its local media for assets to be backed up. The service uses an asset signature to identify assets to be backed up. The asset signature contains information that describes the general structure of an application's asset regardless of any user content present in the asset.

The invention also includes a service that detects when running applications create or modify assets. As applications create or modify assets that match a particular signature they are automatically scheduled for backup.

It is therefore an object of the invention to provide a computer method for backing up client data files, whereby an application program in a first client computer of a plurality of client computers, the client computers having respective client files, creating a backup signature list, the backup signature list comprising one or more backup signatures, each backup signature comprising file; identifying information for identifying first client data files to be backed up; identifying in the first computer system one or more data files of the respective first client computer to be backed up according to corresponding backup signatures in said backup signature list; determining at the first client computer, which respective identified one or more data files to be backed up are to be sent to one or more backup servers; and sending a backup copy of each of the identified one or more data files to be backed up from the respective first client computers to a backup server of the one or more backup servers.

It is a further object of the invention to repeat the method for a plurality of first client computers of said plurality of client computers.

It another object of the invention to support data files consisting of any one of text files, binary files, image files, video files, audio files or program files.

It as yet another object of the invention to receive said sent backup copy of the identified one or more data files to be backed up at one of said one or more backup servers; and said backup server saving said sent backup copy in a backup storage of said one of said one or more backup servers.

It is still another object of the invention to provide said backup signature list consisting of any one of: a list of file extensions a second application program will use when creating data files, a list of byte signatures, the byte signatures to which corresponding data files created by the second application will adhere, a list of behaviors that describe how the application interacts with the storage system associated with the first client, or a definition describing a preferred order of evaluation of said signatures.

It is another object of the invention to create the backup signature list by any one of a third application program for crating client data files, a fourth application for prompting a user for backup signature information or user provided signature list.

It is yet another object of the invention wherein the determining step is performed by any one of a periodic scan of the client system, a user initiated GUI directive or an application program initiated event.

It is another object of the invention to schedule the sending step according to a predetermined plan.

It is another object of the invention to provide the predetermined plan comprising a time period, a file prioritization scheme, a file type prioritization scheme or an application determined plan.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 is a diagram depicting the backup system complete with backup clients, server and client assets on the backup server;

FIG. 2 is a diagram depicting the client system with the invention's individual parts: manager service, application signatures, scanner process, monitor process and backup scheduler;

FIG. 3 is a diagram depicting the steps taken during a scan of all assets on the client machine;

FIG. 4 is a diagram depicting the steps taken while matching asset contents against asset signatures;

FIG. 5 is a diagram depicting the steps taken during the monitor service startup;

FIG. 6 is a diagram depicting the steps taken while registering an application with the monitor service;

FIG. 7 is a diagram depicting the steps taken during the monitor service's execution;

FIG. 8 is a diagram depicting an application centric view of the backup service;

FIG. 9 depicts a computer system of the prior art; and

FIG. 10 depicts a prior art network of computer systems.

The detailed description explains the preferred embodiments of the invention, together with advantages and features, by way of example with reference to the drawings.

### DESCRIPTION OF PREFERRED EMBODIMENTS

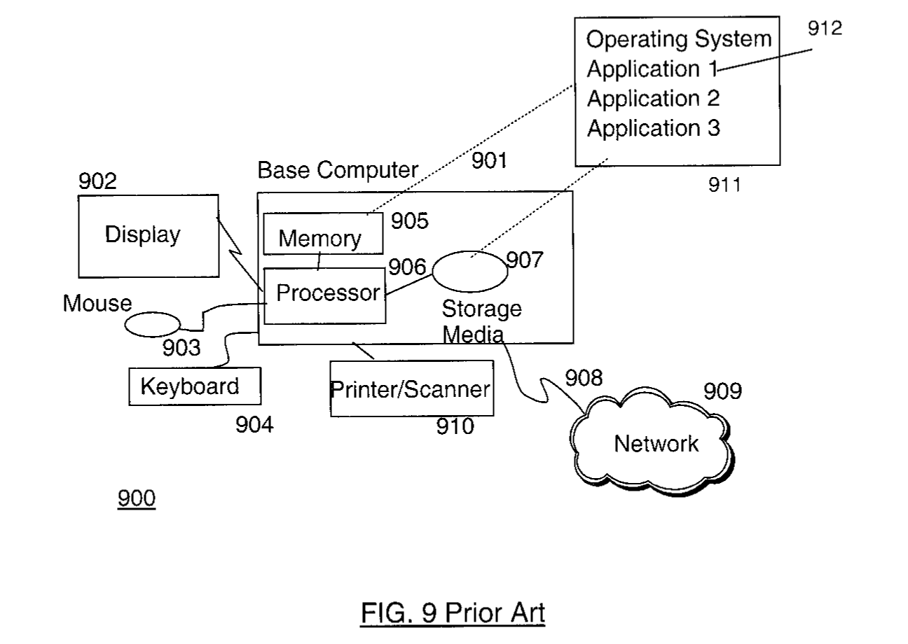

FIG. 9 illustrates a representative workstation or server hardware system in which the present invention may be practiced. The system 900 of FIG. 9 comprises a representative computer system 901, such as a personal computer, a workstation or a server, including optional peripheral devices. The workstation 901 includes one or more processors 906 and a bus employed to connect and enable communication between the processor(s) 906 and the other components of the system 901 in accordance with known techniques. The bus connects the processor 906 to memory 905 and long-term storage 907 which can include a hard drive, diskette drive or tape drive for example. The system 901 might also include a user interface adapter, which connects the microprocessor 906 via the bus to one or more interface devices, such as a keyboard 904, mouse 903, a Printer/scanner 910 and/or other interface devices, which can be any user interface device, such as a touch sensitive screen, digitized entry pad, etc. The bus also connects a display device 902, such as an LCD screen or monitor, to the microprocessor 906 via a display adapter.

The system 901 may communicate with other computers or networks of computers by way of a network adapter capable of communicating 908 with a network 909. Example network adapters are communications channels, token ring, Ethernet or modems. Alternatively, the workstation 901 may communicate using a wireless interface, such as a CDPD (cellular digital packet data) card. The workstation 901 may be associated with such other computers in a Local Area Network (LAN) or a Wide Area Network (WAN), or the workstation 901 can be a client in a client/server arrangement with another computer, etc. All of these configurations, as well as the appropriate communications hardware and software, are known in the art.

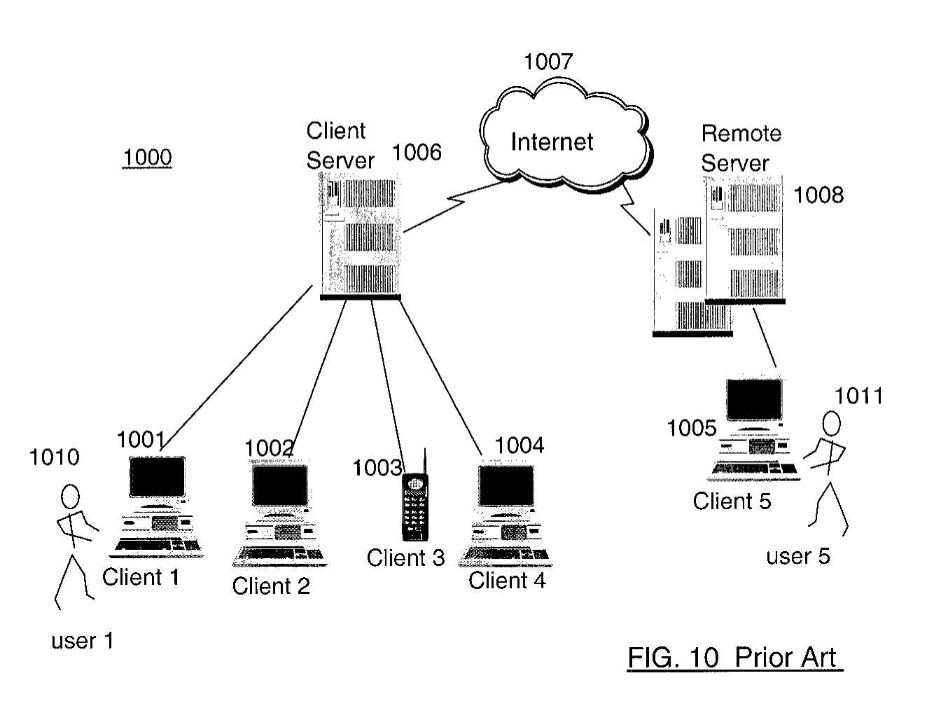

FIG. 10 illustrates a data processing network 1000 in which the present invention may be practiced. The data processing network 1000 may include a plurality of individual networks, such as a wireless network and a wired network, each of which may include a plurality of individual workstations 901 1001 1002 1003 1004. Additionally, as those skilled in the art will appreciate, one or more LANs may be included, where a LAN may comprise a plurality of intelligent workstations coupled to a host processor.

Still referring to FIG. 10, the networks may also include mainframe computers or servers, such as a gateway computer (client server 1006) or application server (remote server 1008 which may access a data repository and may also be accessed directly from a workstation 1005). A gateway computer 1006 serves as a point of entry into each network 1007. A gateway is needed when connecting one networking protocol to another. The gateway 1006 may be preferably coupled to another network (the Internet 1007 for example) by means of a communications link. The gateway 1006 may also be directly coupled to one or more workstations 901 1001 1002 1003 1004 using a communications link. The gateway computer may be implemented utilizing an IBM eServer zSeries® 900 Server available from IBM Corp.

Software programming code which embodies the present invention is typically accessed by the processor 906 of the system 901 from long-term storage media 907, such as a CD-ROM drive or hard drive. The software programming code may be embodied on any of a variety of known media for use with a data processing system, such as a diskette, hard drive, or CD-ROM. The code may be distributed (deployed) on such media, or may be distributed to users 1010 1011 from the memory or storage of one computer system over a network to other computer systems for use by users of such other systems.

Alternatively, the programming code 911 may be embodied in the memory 905, and accessed by the processor 906 using the processor bus. Such programming code includes an operating system which controls the function and interaction of the various computer components and one or more application programs 912. Program code is normally paged from dense storage media 907 to high-speed memory 905 where it is available for processing by the processor 906. The techniques and methods for embodying software programming code in memory, on physical media, and/or distributing software code via networks are well known and will not be further discussed herein.

The present invention may be practiced within a single computer or across a network of cooperating computers.

According to the present invention, data at client computer systems is analyzed according to predetermined “signatures” in order to determine whether a file should be a candidate for backing up in a data backup server, remote from the client system. Each client computer preferably has a list of signatures appropriate to that user's file needs. Periodically, each client reviews its own local files using signatures on the list to determine which file or files are candidates to backup (archive). When the client determines to backup files, the client sends selected candidate files to a backup server. The backup server preferably has responsibility for backing up files of a plurality of client computer systems. Preferably, the client sends additional information with the file to be backed up, which information is useful in managing the backed up copies and retrieval thereof. Such additional information preferably includes a corresponding signature, identity of the client computer, identity of a user of the client computer, identity of an application at the client computer related to the file to be backed up, a time stamp indicating the time the file was last modified or any other information well known in the art. Furthermore, the candidate files may be analyzed to determine which files should be backed up, for instance, whether the file has been modified since last backup and how long since the file was last backed-up.

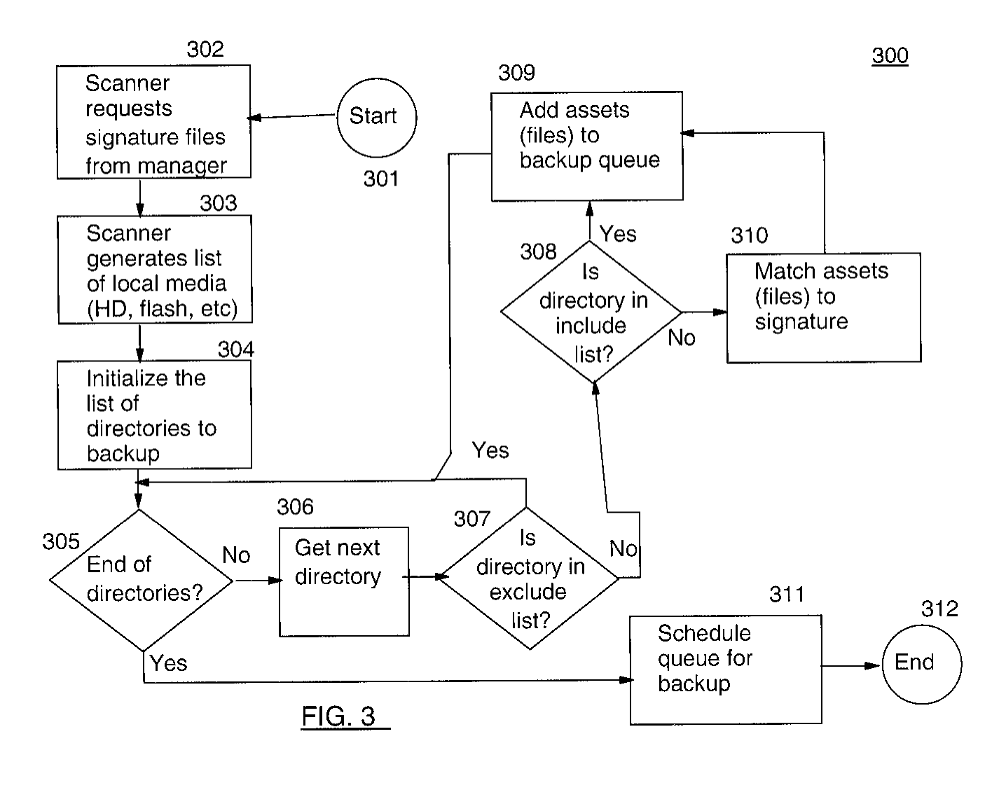

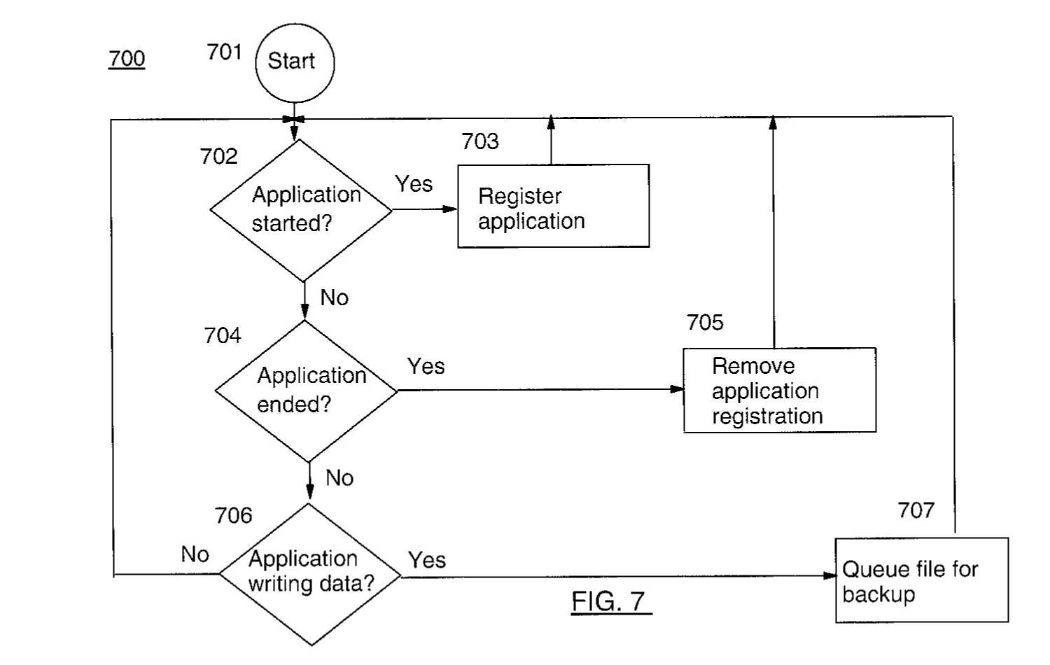

Application signature files preferably are created automatically by an application according to application specific requirements identified by the application vendor. Application signature files may also be created manually by application users, by a system administrator or by any of a number of means. Application signatures preferably contain one or more pieces of information that allow the (FIG. 3) scanner and (FIG. 7) monitor processes to identify files that must be scheduled for backup. These signatures contain information such as:
A list of file extensions the application will use, e.g. EXTENSION=>(.ext1, .ext2, .ext3)
A list of byte signatures that files created by the application will adhere to, e.g. BYTE SIGNATURE=>(offset(2 bytes FROM BEGINATING™) IS PATTERN (0x0000, 0x0001, 0x000A) {1-3 repetitions})
A list of behaviors that describe how the application interacts with the local storage system, e.g. BEHAVIOR=>(WRITE{“My Documents”, “Desktop”, ANYWHERE=>(monitor, prioritize)})
A definition describing the preferred order of evaluation of the above items, e.g. ORDER=>(byte signature, extension, behavior)

Preferably, in addition to file related information, the application signature file also contains the signature of the running application, e.g.:
FOOTPRINT=><SHA1 sum of 1^{st} MB of running application memory image>

A signature of the running application is used by the monitor process to positively identify an application and retrieve its application signature files. The preceding list is not exhaustive and is illustrative of the kinds and types of information that is present in an application signature. Application signature files are classified into three main types:

application developer,

third party, and

default system.

The signature file provided by the application developer is the very precise and is often used when present. Third party signatures are less preferred than application developer signatures because they are created by developers lacking the specific knowledge of the application's internal workings. The default system signature is the less preferred application signature file. It contains enough information to recognize some of the files generated by an application with a high potential for erroneous classification.

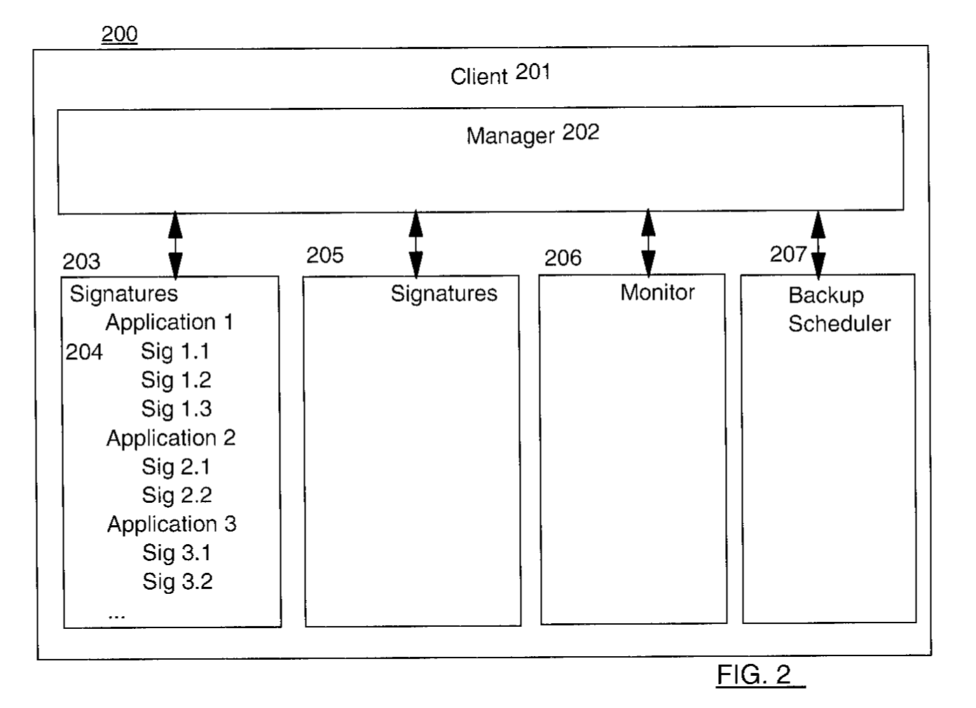

In a preferred embodiment, the user has three applications installed and running on his system: Microsoft® Word, IBM® Lotus Freelance Graphics and Microsoft® Money. The application vendor, Microsoft®, has provided an application signature for Microsoft Word but not Microsoft Money; IBM has provided an application signature for Lotus Freelance. The installation programs used to install Microsoft Money and IBM Lotus Freelance register the respective applications signatures with the client backup manager (FIG. 2). The installation program for Microsoft Money does not have an application signature and as such does not register anything with the client backup manager (FIG. 2). At the conclusion of the installation of Microsoft Money, the user creates a simple application signature for Microsoft Money; this signature is classified as a third-party signature because it does not originate from the application vendor. At this point, the scanner process (FIG. 3) can begin and the files on the local system are compared to the registered application signatures. Because Microsoft Word and IBM Lotus Freelance have signatures provided by the application vendor, all files created with either application are scheduled for backup. Files created with Microsoft Money, not having a application vendor provided signature, are not always positively identified for backup while others are falsely identified as Microsoft Money files and scheduled for backup. It should be noted that a scanner process (FIG. 3) might be imitated by an application, by a client event, by a time of day trigger, or by any means well known in the art for initiating events.

When either Microsoft Word or IBM Lotus Freelance are running and resident in memory there behavior is preferably monitored by an application monitor (FIG. 7) for any file manipulation. If a file being manipulated by either application matches a signature then it is scheduled for backup. Monitoring Microsoft Money suffers from the same problem as the scanner process: because the signature is incomplete some files fail to be scheduled for backup while others are erroneously scheduled for backup.

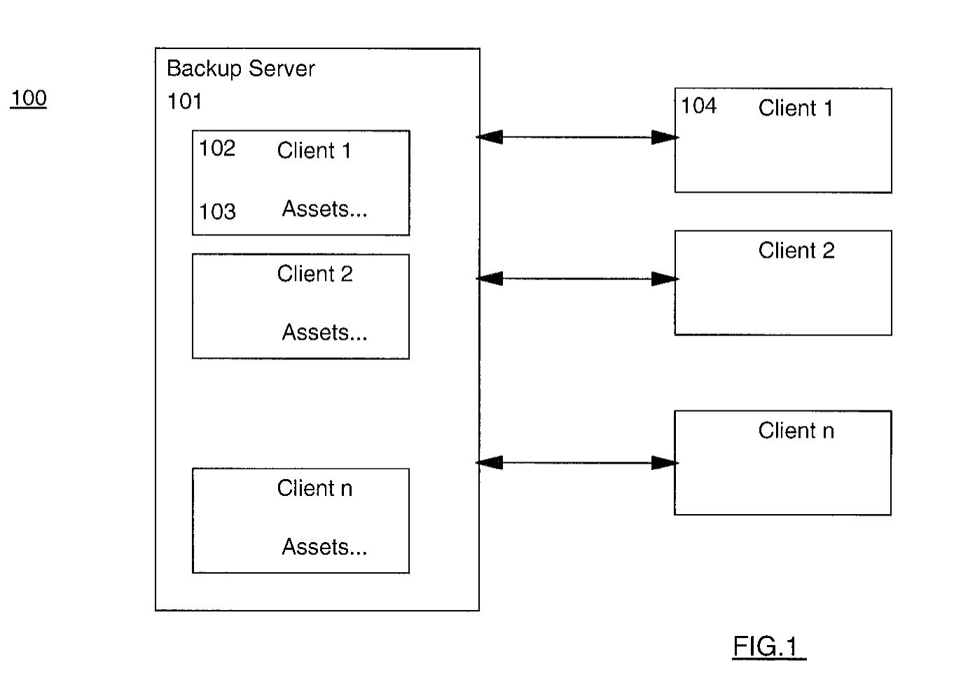

FIG. 1 depicts an exemplary client (104)/server (101) backup system. The backup server is connected to a network with a large non-volatile storage system. Client systems send data to the backup server to be preserved in the event of a client failure. The backup server preferably groups the incoming data assets (103) by client system.

FIG. 2 depicts the components used by the client system (201) while gathering and transferring backup data. The client system preferably comprises a manager process (202) that is responsible for coordinating the other backup related processes. The application signature repository (203) contains a prioritized list of application signatures (204) the scanner process uses to differentiate between files that need to be backed up and those that do not. The scanner process (205) can be used to scan a new system to identify those assets (application files) to be backed up. The monitor process (206) watches application activity in order to quickly schedule files for backup. The backup scheduler (207) is responsible for scheduling the actual transfer of files to the backup server.

FIG. 3 depicts flow of an example scanner process. The scanner process first requests the list of application signatures from the manager process (302). Next, the scanner process generates (303) a list of local media that will be examined for files requiring backup. A list of directories to be scanned is generated (304). Now the main scanner process loop begins. The scanner checks (305) to see if its list of directories is empty. If YES, the scanner notifies (311) the backup scheduler that files need to be sent to the backup server and then ends (312). If NO, the scanner process retrieves (306) the next directory and checks (307) to see if it is in the exclude list. If the directory is in the exclude list, the scanner returns to the beginning (305) of this loop. If the directory is in the include list (308), the scanner process adds (309) its contents to the backup queue and returns to the beginning (305) of this loop. If the directory is not in the include list the scanner process iterates (310) through the list of files in the directory attempting to match each file to an application signature. Each file that matches an application signature is added to the backup queue.

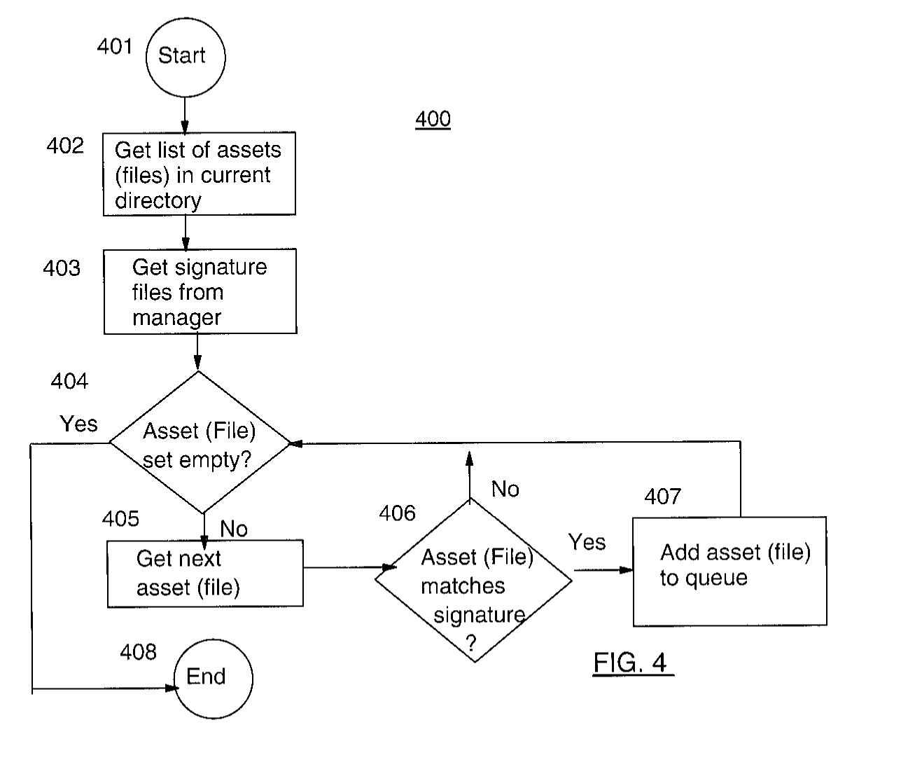

### (Reference FIG. 4)

FIG. 4 depicts the process used to match files to application signatures (310). The process begins by retrieving (402) the list of files in the current directory. Then the list of application signatures is retrieved (403) from the manager process. Next, the match process begins its main loop by checking (404) to see if its list of files is empty. If YES, then the process ends (408). If NO, the match process retrieves (405) the next file in the list and then attempts (406) to match it against one of the application signatures in its application signature list. If no application signature matches the file then the process returns to the beginning of its main loop (404). If the file matches an application signature, then it is added (407) to the backup queue and the process returns to the beginning of the main loop (404).

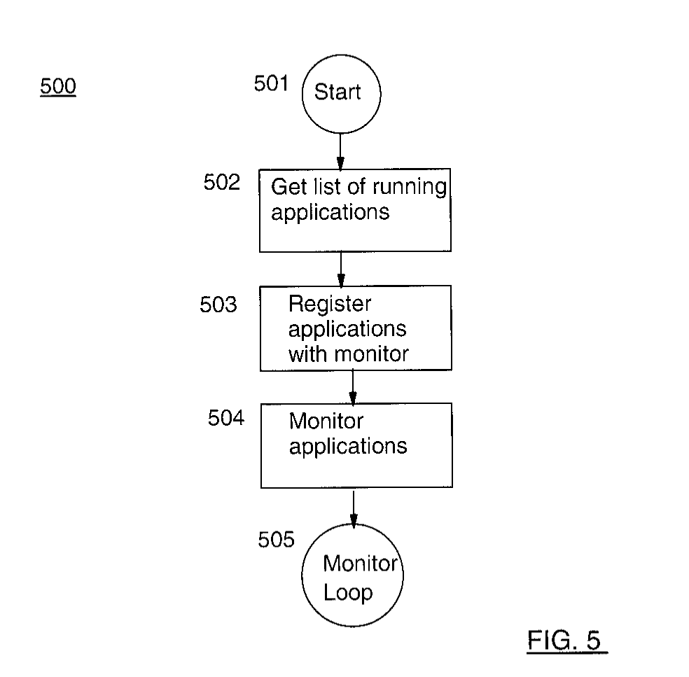

FIG. 5 depicts an example of a start and initialization of the monitor process. A list of running applications is generated (502). The generated list is then registered (503) with the monitor process at which point the monitor process enters its main monitor loop (505).

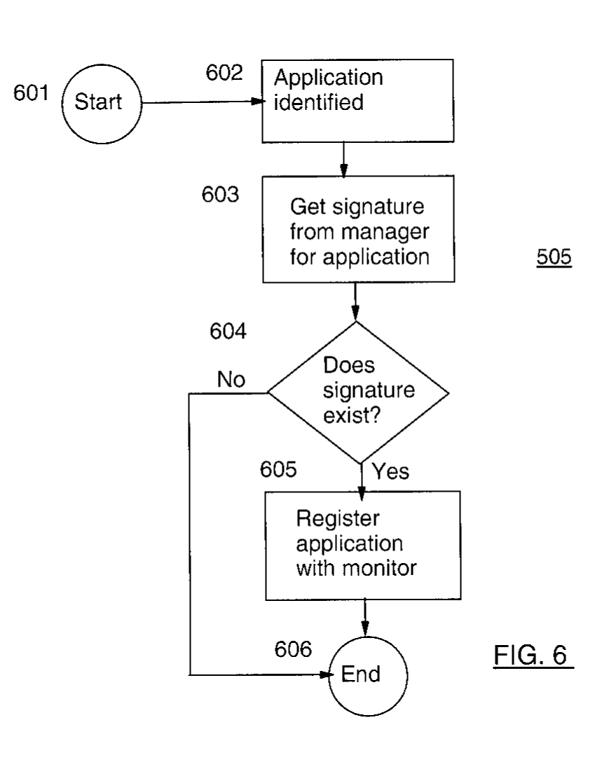

FIG. 6 depicts an example process used to register an application with the monitor process. The process first checks (602) to see if the application is known to the system. If the application is not known to the system it is skipped. If the application is known to the system then the process requests (603) the list of application signatures from the manager process. If (604) the application signature list is empty, then the application is not registered and the process ends (606). If the application signature list is not empty, then the application is registered (605) with the application monitor.

FIG. 7 depicts an example monitoring process 700. The monitoring process watches for a set of events that guide its behavior. These events include, for example, but are not limited to application start, application end, and application writing data. If the monitoring process notices an application starting (702) then it registers (703) that application with the system. As a result, it retrieves the applications signature description. If (704) the application has ended, then the application is removed (705) from the application registry. If (706) the application is writing data, the file is queued (707) for backup if it matches an application signature. Otherwise, the monitor continues to the beginning (701) band starts over.

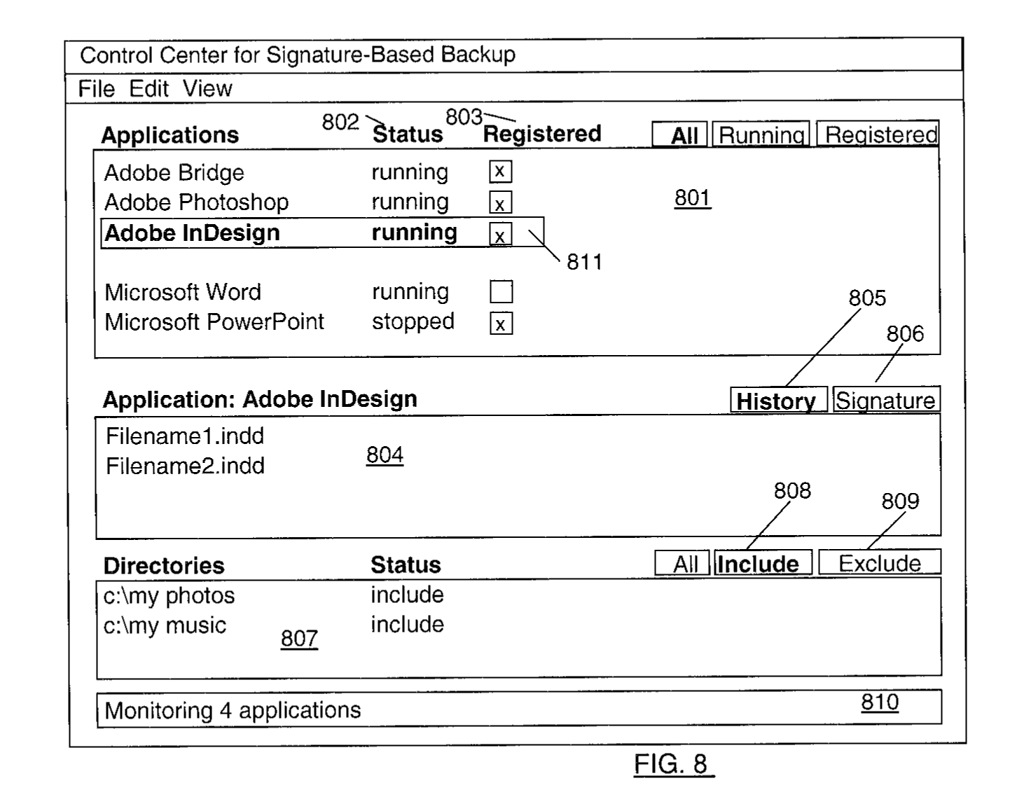

FIG. 8 depicts an example user interface (GUI)_for this application. This is only one embodiment of possible embodiments of this invention presented to teach elements of the invention by showing a sample interaction with the system. In the example, the user interface presents an application centric view 800 of the files on the system and allows the user to monitor and control the backup process. The first window pane (801) shows application status (802). Those applications that are running or not and have been registered (804) or not. In the example Adobe Bridge is running and registered while Microsoft Word is running but not registered and Microsoft PowerPOint is registered but not running (stopped). The second window pane (804) illustrates the files that have been generated by the application selected (811) in the first pane 801. (Adobe InDesign shown highlighted (811) in the first pane 801 to indicate selection where selection is accomplished via manipulating a cursor with a computer mouse for example). This pane 804 can show the history (805) for the selected application or the signature description (806) for the application. The final window pane (807) shows the status of the directories that are part of the include list. The Include list is displayed responsive to selection of the Include radio button (808). Similarly and exclude list could be displayed by selecting the Exclude radio button (809). The status line (810) displays relevant information, in the present example, the status line (810) displays the number of applications running that are being monitored.

What is claimed is:

1. A computer method for backing up client data files, the method comprising the steps of:
a) in a first client computer of a plurality of client computers, the client computers having respective client data files, an application program creating a backup signature list, the backup signature list comprising one or more backup signatures, each backup signature comprising file identifying information for identifying first client data files to be backed up;
b) in the first client computer, identifying one or more first data files of the respective first client computer to be backed up according to corresponding backup signatures in said backup signature list;
c) determining at the first client computer, which respective identified one or more first data files to be backed up are to be sent to one or more backup servers; and
d) sending a backup copy of each of the determined one or more first data files to be backed up from the respective first client computer to a backup server of the one or more backup servers.

2. The method according to claim 1, comprising the further step of:
repeating steps a) through d) for a plurality of first client computers of said plurality of client computers.

3. The method according to claim 1, wherein data files consist of any one of text files, binary files, image files, video files, audio files or program files.

4. The method according to claim 1, comprising the further steps of:
receiving said sent backup copy of the determined one or more first data files to be backed up at one of said one or more backup servers; and
said backup server saving said sent backup copy in a backup storage of said one of said one or more backup servers

5. The method according to claim 1, wherein said backup signature list consists of any one of:
a list of file extensions a second application program will use when creating data files,
a list of byte signatures, the byte signatures to which corresponding data files created by the second application will adhere,
a list of behaviors that describe how the application interacts with the storage system associated with the first client, or
a definition describing a preferred order of evaluation of said signatures.

6. The method according to claim 1, wherein the backup signature list is created by any one of a third application program for crating client data files, a fourth application for prompting a user for backup signature information or user provided signature list.

7. The method according to claim 1, wherein the determining step is performed by any one of a periodic scan of the client system, a user initiated GUI directive or an application program initiated event.

8. The method according to claim 1, comprising the further step of scheduling the sending step according to a predetermined plan.

9. The method according to claim 8, wherein the predetermined plan consists of any one of a time period, a file prioritization scheme, a file type prioritization scheme or an application determined plan.

10. A system for backing up client data files, the system comprising:
a plurality of client computers, each client computer comprising storage for holding one or more client data files;
one or more backup servers in network communication with said plurality of client computers;
wherein the system performs a method comprising:
a) in a first client computer of the plurality of client computers, the client computers having respective client data files, an application program creating a backup signature list, the backup signature list comprising one or more backup signatures, each backup signature comprising file identifying information for identifying first client data files to be backed up;
b) in the first client computer, identifying one or more first data files of the respective first client computer to be backed up according to corresponding backup signatures in said backup signature list;
c) determining at the first client computer, which respective identified one or more first data files to be backed up are to be sent to one or more backup servers; and
d) sending a backup copy of each of the determined one or more first data files to be backed up from the respective first client computer to a backup server of the one or more backup servers.

11. The system according to claim 10, comprising the further step of:
repeating steps a) through d) for a plurality of first client computers of said plurality of client computers.

12. The system according to claim 10, wherein data files consist of any one of text files, binary files, image files, video files, audio files or program files.

13. The system according to claim 10, comprising the further steps of:
receiving said sent backup copy of the determined one or more first data files to be backed up at one of said one or more backup servers; and
said backup server saving said sent backup copy in a backup storage of said one of said one or more backup servers

14. The system according to claim 10, wherein said backup signature list consists of any one of:
a list of file extensions a second application program will use when creating data files,
a list of byte signatures, the byte signatures to which corresponding data files created by the second application will adhere,
a list of behaviors that describe how the application interacts with the storage system associated with the first client, or
a definition describing a preferred order of evaluation of said signatures.

15. The system according to claim 10, wherein the backup signature list is created by any one of a third application program for crating client data files, a fourth application for prompting a user for backup signature information or user provided signature list.

16. The system according to claim 10, wherein the determining step is performed by any one of a periodic scan of the client system, a user initiated GUI directive or an application program initiated event.

17. The system according to claim 10, comprising the further step of scheduling the sending step according to a predetermined plan.

18. The system according to claim 17, wherein the predetermined plan consists of any one of a time period, a file prioritization scheme, a file type prioritization scheme or an application determined plan.

19. A computer program product for backing up client data files, the computer program product comprising:
a storage medium readable by a processing circuit and storing instructions for execution by the processing circuit for performing a method comprising:
a) in a first client computer of a plurality of client computers, the client computers having respective client data files, an application program creating a backup signature list, the backup signature list comprising one or more backup signatures, each backup signature comprising file identifying information for identifying first client data files to be backed up;
b) in the first client computer, identifying one or more first data files of the respective first client computer to be backed up according to corresponding backup signatures in said backup signature list;
c) determining at the first client computer, which respective identified one or more first data files to be backed up are to be sent to one or more backup servers; and
d) sending a backup copy of each of the determined one or more first data files to be backed up from the respective first client computer to a backup server of the one or more backup servers.

20. The computer program product according to claim 19, comprising the further step of:
repeating steps a) through d) for a plurality of first client computers of said plurality of client computers.

21. The computer program product according to claim 19, wherein data files consist of any one of text files, binary files, image files, video files, audio files or program files.

22. The computer program product according to claim 19, comprising the further steps of:
receiving said sent backup copy of the determined one or more first data files to be backed up at one of said one or more backup servers; and
said backup server saving said sent backup copy in a backup storage of said one of said one or more backup servers

23. The computer program product according to claim 19, wherein said backup signature list consists of any one of:
a list of file extensions a second application program will use when creating data files,
a list of byte signatures, the byte signatures to which corresponding data files created by the second application will adhere,
a list of behaviors that describe how the application interacts with the storage system associated with the first client, or
a definition describing a preferred order of evaluation of said signatures.

24. The computer program product according to claim 19, wherein the backup signature list is created by any one of a third application program for crating client data files, a fourth application for prompting a user for backup signature information or user provided signature list.

25. The computer program product according to claim 19, wherein the determining step is performed by any one of a periodic scan of the client system, a user initiated GUI directive or an application program initiated event.

26. The computer program product according to claim 19, comprising the further step of scheduling the sending step according to a predetermined plan.

27. The computer program product according to claim 26, wherein the predetermined plan consists of any one of a time period, a file prioritization scheme, a file type prioritization scheme or an application determined plan.

28. A computer implemented service for deploying computer readable code to one or more computer systems, the code comprising instructions for execution by a computing system of the one or more computing systems for performing a method for backing up client data files, the method comprising:
a) in a first client computer of a plurality of client computers, the client computers having respective client data files, an application program creating a backup signature list, the backup signature list comprising one or more backup signatures, each backup signature comprising file identifying information for identifying first client data files to be backed up;
b) in the first client computer, identifying one or more first data files of the respective first client computer to be backed up according to corresponding backup signatures in said backup signature list;
c) determining at the first client computer, which respective identified one or more first data files to be backed up are to be sent to one or more backup servers; and
d) sending a backup copy of each of the determined one or more first data files to be backed up from the respective first client computer to a backup server of the one or more backup servers.

29. The service according to claim 28, comprising the further step of:
repeating steps a) through d) for a plurality of first client computers of said plurality of client computers.

30. The service according to claim 28, comprising the further steps of:
receiving said sent backup copy of the determined one or more first data files to be backed up at one of said one or more backup servers; and
said backup server saving said sent backup copy in a backup storage of said one of said one or more backup servers

31. The service according to claim 28, wherein said backup signature list consists of any one of:
a list of file extensions a second application program will use when creating data files,
a list of byte signatures, the byte signatures to which corresponding data files created by the second application will adhere,
a list of behaviors that describe how the application interacts with the storage system associated with the first client, or
a definition describing a preferred order of evaluation of said signatures.

32. The service according to claim 28, comprising the further step of scheduling the sending step according to a predetermined plan.

33. The service according to claim 32, wherein the predetermined plan consists of any one of a time period, a file prioritization scheme, a file type prioritization scheme or an application determined plan.
